(19) United States
(12) Patent Application Publication
(10) Pub. No.: US 2026/0358524 A1
(43) Pub. Date: Nov. 12, 2026

(54) SYSTEMS AND METHODS FOR ANOMALY DETECTION OF SEISMIC MIGRATION USING A GENERATIVE DIFFUSION MODEL

(71) Applicant: SAUDI ARABIAN OIL COMPANY, Dhahran (SA)

(72) Inventor: Bingbing SUN, Dhahran (SA)

(73) Assignee: SAUDI ARABIAN OIL COMPANY, Dhahran (SA)

(21) Appl. No.: 19/200,129

(22) Filed: May 6, 2025

(51) Int. Cl. G01V 1/36; G01V 1/28

(52) U.S. Cl. CPC G01V 1/36; G01V 1/282

(57) ABSTRACT

This disclosure provides methods for seismic anomaly detection using generative diffusion modelling (GDM) and systems for performing the same. For example, methods may include constructing multidimensional diffusion structures based on non-anomalous seismic information. Methods may include training a neural network based on the multidimensional diffusion structures and an evidence lower bound (ELBO). Methods may include applying the neural network to a seismic anomaly profile constructed using the non-anomalous seismic information to identify one or more seismic anomalies. Methods may include generating an attributes map indicating the one or more seismic anomalies.

### BACKGROUND

Fault detection is important in a seismic operations. Fault detection often relies on detecting anomalies in subsurface conditions. Current anomaly detection methods in seismic interpretation include several challenges that can impact the accuracy and reliability of subsurface mapping. These challenges include the presence of noise and artifacts in the seismic data, which can obscure true geological features and complicate interpretation. The complex and heterogeneous nature of subsurface structures can lead to multiple reflections and refractions, making it difficult to accurately identify faults. Traditional anomaly detection methods, which often rely on manual tuning and interpretation, may not be sufficient to handle the complexity of real-world geological formations, leading to subjective and time-consuming processes. Furthermore, the computational intensity of these methods can result in significant resource consumption and longer processing times, limiting the scalability and efficiency of these techniques.

Despite advancements in anomaly detection techniques, current methods may still be ineffective in achieving optimal results. Accordingly, there is a need to improve anomaly detection techniques to overcome existing technological challenges by implementing enhancements such as: increasing the reliability of subsurface mapping, reducing inefficiencies associated with the detection process, minimizing the impact of noise and artifacts, decreasing the reliance on manual interpretation, and improving the accuracy of automated solutions.

### SUMMARY

Various details of the present disclosure are hereinafter summarized to provide a basic understanding. This summary is not an exhaustive overview of the disclosure and is neither in-tended to identify certain elements of the disclosure, nor to delineate the scope thereof. Rather, the primary purpose of this summary is to present some concepts of the disclosure in a simplified form prior to the more detailed description that is presented hereinafter.

According to an aspect of the present disclosure, a system for seismic processing may include a memory. A system for seismic processing may include one or more processors coupled to the memory, the memory having computer-readable code stored thereon configured to cause the one or more processors to perform one or more steps. The one or more steps may include constructing, via the one or more processors, one or more multidimensional diffusion structures based on non-anomalous seismic information. The one or more steps may include training, via a machine learning engine at the system, a neural network based on the one or more multidimensional diffusion structures and at least one loss function of an evidence lower bound. The one or more steps may include applying the neural network to a seismic anomaly profile constructed using the non-anomalous seismic information to identify one or more seismic anomalies. Applying may include generating one or more noise samples by applying the neural network and a weighting term to a first pixel of the seismic anomaly profile. Applying may include detecting a difference between an expected value for the one or more noise samples and an actual value for the one or more noise samples, the difference indicating the one or more seismic anomalies. The one or more steps may include based on the one or more seismic anomalies, generating an attributes map indicating the one or more seismic anomalies.

In another aspect, a method for seismic processing may include constructing, via one or more processors, one or more denoising diffusion probabilistic models based on non-anomalous seismic information. The method may include training, via a machine learning engine, a neural network based on the one or more denoising diffusion probabilistic models and an evidence lower bound. The method may include applying the neural network to a seismic anomaly profile constructed using the non-anomalous seismic information to identify one or more seismic anomalies. Applying may include generating one or more noise samples by applying the neural network and a weighting term to a first pixel of the seismic anomaly profile. Applying may include detecting a difference between an expected value for the one or more noise samples and an actual value for the one or more noise samples, the difference indicating the one or more seismic anomalies. The method may include based on the one or more seismic anomalies, generating an attributes map indicating the one or more seismic anomalies.

In another aspect, a system for seismic processing may include an anomaly detection manager. The anomaly detection manager may be configured to construct one or more multidimensional diffusion structures based on non-anomalous seismic information. The anomaly detection manager may include a training engine. The training engine may be configured to train a neural network based on the one or more multidimensional diffusion structures and at least one loss function of an evidence lower bound. The anomaly detection manager may include an inference engine. The inference engine may be electronically coupled to the training engine. The inference engine may be configured to apply the neural network to a seismic anomaly profile constructed using the non-anomalous seismic information to identify one or more seismic anomalies. Applying may include generating one or more noise samples by applying the neural network and a weighting term to a first pixel of the seismic anomaly profile. Applying may include detecting a difference between an expected value for the one or more noise samples and an actual value for the one or more noise samples, the difference indicating the one or more seismic anomalies. The system may include a seismic model manager electronically coupled to the anomaly detection manager and configured to, based on the one or more seismic anomalies, generating an attributes map indicating the one or more seismic anomalies.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

FIG. 1 depicts an example of an enhanced anomaly detection architecture for implementing methods provided herein, according to at least one aspect of the present disclosure.

FIG. 2 depicts an example of an enhanced workflow for anomaly detection, according to at least one aspect of the present disclosure.

FIG. 3 depicts an example set of denoising diffusion probabilistic model (DDPM) training patches made of non-anomalous two dimensional (2D) seismic profiles, according to at least one aspect of the present disclosure.

FIG. 4 depicts an example set of DDPM input patches corresponding to at least one 2D seismic anomaly profile, according to at least one aspect of the present disclosure.

FIG. 5 depicts an example set of detected noise patches corresponding to the patches of FIG. 4, the noise patches indicating predicted and unpredicted noise according to at least one aspect of the present disclosure.

FIG. 6 depicts the patches of FIG. 4 with the unpredicted noise of FIG. 5 overlain to illustrate predicted fault structures, according to at least one aspect of the present disclosure.

FIG. 7 is a schematic flowchart of an example method for implementing enhanced anomaly detection by one or more processors, according to at least one embodiment of the present disclosure.

FIG. 8 illustrates a schematic diagram of an example system, according to at least one embodiment of the present disclosure.

FIG. 9 is an example of a block diagram of a system, according to at least one embodiment of the present disclosure.

FIG. 10 depicts a cloud computing environment that can be used to perform one or more actions according to an aspect of the present disclosure.

FIG. 11 is a block diagram of a computer system that may be used to implement one or more of the systems or methods described herein in accordance with certain embodiments.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Aspects in accordance with the present disclosure generally relate to subsurface interpretation techniques, and more particularly to systems and methods for enhancing anomaly detection using integrated generative diffusion models.

Disclosed herein are systems and methods to improve the anomaly detection in seismic interpretation, a significant step in subsurface mapping. Traditional anomaly detection techniques, such as eigen-structure coherence, gradient structure tensor, energy-ratio similarity, and variance, are typically hand-crafted and based on principles of edge detection. These conventional methods assume that the ideal seismic data maintains certain patterns, often leading to subjective and time-consuming processes. To achieve more accurate fault detection in seismic interpretation, the present disclosure utilizes denoising diffusion probabilistic models (DDPMs) to enhance the detection process.

For example, the systems and methods described herein may utilize a two-step process for fault detection based on the anomaly detection framework using DDPMs. The first step involves training a neural network to predict the noise in the seismic data by minimizing a specific loss function, allowing the network to learn the noise characteristics. The second step involves computing the fault attribute for a seismic image using a pixel-wise version of the loss function as an indicator for anomalies. This process includes sampling a time step and noise, adding this noise to the input seismic image, and then using the trained neural network to predict the noise. The presence of unpredictable noise indicates anomalies in the input samples, thereby identifying faults. Multiple samples are taken, and the results are averaged to obtain the final predicted faults. Preliminary results of implementing the systems and methods provided herein demonstrate the effectiveness and robustness of the proposed fault detection methods to produce refined subsurface models.

### Seismic Interpretation

Seismic interpretation aims to derive geological and reservoir information from the seismic data. In general, seismic interpretation begins with the analysis of seismic data, typically gathered through the use of seismic sources and receivers deployed in the field. This data may be in the form of time records that capture the reflections of seismic waves off subsurface structures. The first step in interpreting this data involves identifying key seismic horizons, which are surfaces that represent significant geological boundaries. Following horizon identification, the data may be subjected to fault interpretation to delineate structural discontinuities within the subsurface. Faults are mapped by tracing the offsets in seismic reflections, which indicate the presence of fractures or displacements in the geological formation. The process of fault interpretation involves careful examination of seismic sections to ensure accurate mapping of these features. The identified horizons and faults are used to build a structural framework of the subsurface, providing a basis for further geological analysis.

The general workflow of seismic interpretation may involve several steps. Initially, interpreted seismic horizons and faults are input into a geological modeling software. Methods such as structural modeling and stratigraphic interpretation may be used. Structural modeling involves creating a three-dimensional representation of the subsurface, incorporating the interpreted horizons and faults. Stratigraphic interpretation focuses on understanding the depositional environment and sedimentary processes that formed the geological layers. These methods involve detailed analysis of seismic attributes and well data to refine the geological model. Geological features are identified by examining the seismic reflections and their continuity, amplitude, and geometry. Advanced interpretation techniques, such as seismic facies analysis and attribute mapping, can also be applied. These techniques involve various geological and geophysical methods to ensure that the features are accurately identified and validated against known subsurface conditions. The output is a comprehensive geological model that accurately represents the subsurface structures and stratigraphy, providing valuable insights for exploration and production.

These geological models may be used for further geological and reservoir characterization, aiding in decision-making processes for exploration and production. The quality of the seismic data processing directly affects interpretation results. If the seismic data processing produced data that has flaws, the resulting geological model may be inaccurate, potentially leading to less reliable outcomes. Therefore, ensuring high-quality seismic processing is considered essential for achieving reliable and precise geological interpretations.

### Anomaly Detection

Anomaly detection may play a critical role in seismic interpretation, serving as a cornerstone for accurate subsurface mapping. It may facilitate identification of geological features that may significantly impact the exploration and production of hydrocarbons. Precise anomaly detection may help delineate reservoir boundaries, identify faults, understand fluid migration pathways, and assess compartmentalization within the reservoir. Moreover, anomaly detection may aid in evaluating geohazards, which may be crucial for the safety and planning of drilling operations. The ability to accurately interpret seismic data for anomaly detection directly influences the economic feasibility of resource extraction projects and the mitigation of environmental risks.

The detection of faults in seismic images may be classified into two categories: conventional approaches and machine learning approaches. Conventional methods for fault detection primarily involve the analysis of discontinuities in seismic data. Techniques such as eigen-structure coherence, gradient structure tensor, energy-ratio similarity, and variance are employed to highlight faults within three dimensional (3D) seismic volumes. These methods are based on the principle of edge detection, where algorithms identify sudden changes in the seismic signal that may indicate the presence of a fault. The effectiveness of these techniques depends on their ability to enhance the visibility of faults while suppressing noise. However, they often require manual tuning and interpretation, which may be time-consuming and subjective.

On the other hand, machine learning-based methods, particularly those involving convolutional neural networks (CNNs), may enable more precise fault detection in seismic images. These methods leverage “deep learning” techniques to automatically learn from data features that are indicative of faults. Deep learning is a subset of machine learning that utilizes neural networks with many layers (e.g., deep neural networks) to model complex patterns in data. Deep learning leverages large datasets and high computational power to automatically learn hierarchical feature representations, enabling tasks such as seismic interpretation, fault detection, and reservoir characterization. The training process involves backpropagation and gradient descent to minimize the loss function and optimize the network's weights. CNNs are trained using labeled datasets, where the input is seismic images and the output is the location of faults. Once trained, these models can process new seismic data to detect faults with high accuracy and efficiency. Machine learning approaches are particularly adept at handling complex data and may significantly reduce the time and effort required for interpretation compared to conventional methods.

### Aspects Related to Anomaly Detection Using a Generative Diffusion Model

Machine learning techniques implemented herein may provide sophisticated algorithms capable of identifying subtle patterns in seismic data that may indicate the presence of faults.

In certain cases, generative diffusion models (GDMs) may be useful for anomaly detection in pre- and post-processed geological models. GDMs are a type of deep-learning, generative machine learning model that can construct a representative diffusion process to generate new data samples. GDM techniques may start with a simple distribution, like Gaussian noise, and gradually transform it into a complex data distribution, such as images or text, through a series of small diffusion steps. In other word, GDMs transform data into latent space using a Markov chain that gradually adds Gaussian noise over a series of steps. Then, GDMs learn to reverse this process by training a neural network to predict the noise that was added at each step. By iteratively denoising the data, the model can generate new samples from random noise that resemble the training data.

Aspects of the present disclosure provide a method and system to detect anomalies (e.g., faults) in seismic data using one of more GDMs. Methods and systems provided herein, by way of the GDMs, may improve the efficiency and fidelity of seismic interpretation procedures.

In at least one aspect of the present disclosure, a DDPM is used as a GDM during anomaly detection, though other GDMs are contemplated within the scope of the disclosure. These models, particularly DDPMs, have shown promise in various applications, from unsupervised to semi-supervised settings. For instance, in the realm of an Internet of Things (IoT) environment with networked sensors, machine learning approaches utilizing generative models can detect anomalies in sensor data, which may be crucial for maintaining system integrity. Each application may utilize a tailored approach, adjusting the model's sensitivity and specificity to the domain's unique data characteristics and anomaly definitions.

DDPMs may include two Markov processes. The first process may be considered a forward process and the second may be considered backwards process. The forward process may be a fixed diffusion process where the original data is gradually corrupted by adding Gaussian noise until it becomes completely random. Conversely, in the reverse process, the model (e.g., implemented by a neural network) may learn to reverse this process, starting from the noisy data and progressively removing the noise to recover the original data.

Additional information regarding the DDPM forward and backwards processes are provided herein. It should be understood that any equation (e.g., Equations [1]-[11]) provided herein with respect to the present disclosure is illustrative to describe processor operations by a seismic computer system configured or otherwise arranged to efficiently perform methods provided herein. A dedicated computer system for seismic tasks is necessary to perform seismic modelling. Typically, dedicated computer systems for seismic tasks include high-performance computing (HPC) resources by way of the intensive computational demands of these processes. A dedicated computer system for seismic tasks may include a cluster of interconnected servers, each equipped with multiple high-speed processors (CPUs) or graphics processing units (GPUs) to handle parallel processing tasks efficiently. Parallelization is crucial in this context, as it allows the distribution of complex mathematical computations across multiple processors, significantly reducing processing time and enhancing performance. These processors should have high core counts and fast clock speeds to manage the parallelized tasks involved in migration and inversion algorithms. Additionally, the dedicated computer systems for seismic tasks should have substantial memory, often in the range of about hundreds of gigabytes to terabytes, to store and process large datasets without bottlenecks. High-speed storage solutions, such as solid-state drives (SSDs) or high-performance network-attached storage (NAS), are essential for quick data access and retrieval. The network infrastructure should support high bandwidth and low latency to facilitate rapid data transfer between nodes in the cluster. Finally, robust cooling systems and power supplies are necessary to ensure the hardware operates reliably under the heavy computational loads typical of seismic data processing tasks.

### DDPMs Forward Process

The forward Markov process q may be defined in Equation [1]:

$$q ( {x}_{1} , {x}_{2} , … , {x}_{T} \vert {x}_{0} ) = {\prod }_{t = 1}^{T} q ( {x}_{t} \vert {x}_{t - 1} ) , \qquad [ 1 ]$$

where T may be considered the total number of steps for diffusion, xᵢ, i=0, . . . , T may be considered a multidimensional array (e.g., such as one or more seismic images for use in fault detection) in different time steps. Specially, x, may be considered the sample from the data distribution (e.g., a normal fault-free seismic image), while xᵢ may be considered the intermediate samples after incremental diffusion (e.g., adding noise to x₀). The intermediate samples can also be considered as latent variables in the framework of Bayesian variational inference.

At each iteration of the forward process, Gaussian noise may be added according to Equation [2]:

q(xₜ|xₜ₋₁)= [symbol] (xₜ;\sqrt{1−βₜ}xₜ₋₁,βₜI); [2]
where noise schedule parameter βₜ may be considered a scalar value in the range [0,1] and fixed for each time step and I may be considered the identity matrix. With proper defined βₜ, the forward diffusion process tries to reduce the information content and enhance the noise level. To speed up the training, systems and methods provided herein can sample arbitrary time step t without referring to the chain formula as follows:

q(xₜ|x₀)= [symbol] (xₜ,\sqrt{\tilde{α}ₜ}X₀,(1−\tilde{α}ₜ)I) [3]
with αₜ=1−βₜ and

$$\tilde{{α}_{t}} = {\prod }_{s = 0}^{t} {α}_{s} .$$

With reparameterization, systems and methods provided herein may define an intermediate sample x₀ at time step t as:

x₁=\sqrt{\tilde{α}ₜ}x₀+\sqrt{1−\tilde{α}ₜ}ε,ε~ [symbol] (0,I) [4]

The schedule of βₜ usually makes the resulting distribution q(xₜ|x₀) approaches the standard Gaussian distribution [symbol] (x; 0, I). By the reverse process, systems and methods provided herein can generate the data starting from a random signal.

### DDPMs Reverse Process:

Within the realm of machine learning, the reverse process may be structured as a neural network, with parameters denoted by θ:

$${p}_{θ} ( {x}_{0} , {x}_{1} , … , {x}_{T} ) = p ( {x}_{T} ) {\prod }_{t = 1}^{T} {p}_{θ} ( {x}_{t - 1} \vert {x}_{t} ) . \qquad [ 5 ]$$

Similar to forward process, transition in the reverse step may be defined as Gaussian distribution:

p_{θ}(xₜ₋₁|xₜ)= [symbol] (xₜ₋₁;μ_{θ}(xₜ,t),Σ_{θ}(xₜ,t)). [6]

Here μ_{θ} and Σ_{θ} are the mean and variance, respectively. In DDPMs, the variance part Σ_{θ} may be fixed and not trained, though variations of DDPMs are contemplated in this disclosure.

In at least one embodiment, the DDPM may be trained using a training diffusion model with an evidence lower bound (ELBO) technique:

According to Bayesian variational inference, the loss function for training the DDPMs is given by the evidence lower bound (ELBO), such as provided in Equation [7]:

$$ELBO = {𝔼}_{q ( {x}_{1 : T} \vert {x}_{0} )} [ log \frac{p ( {x}_{T} ) {\prod }_{t = 1}^{T} {p}_{θ} ( {x}_{t - 1} \vert {x}_{t} )}{{\prod }_{t = 1}^{T} q ( {x}_{t} \vert {x}_{t - 1} )} ] \leq log p ( x ) . \qquad [ 7 ]$$

DDPMs may reparametrize the mean, μ_{θ}, in Equation [6] using the added noise ε and simplify the ELBO objective in Equation [7] to be a denoising formula, as follows:

Loss_{ELBO}= [symbol] _{t,x}_{₀}_{,ε}∥ε−ε_{θ}(xₜ=\sqrt{\tilde{α}ₜ}x₀+\sqrt{1−\tilde{α}ₜ}ε,t)∥². [8]

Intuitively, the reverse process can be perceived as making predictions and fitting the introduced noise, denoted as ε. In certain cases, a U-net may be employed for the noise neural network ε_{θ}, given its ability to maintain accuracy and efficient performance in pixel-level prediction tasks.

During the training process, systems and methods provided herein may perform random sampling of the model x₀, noise ε and diffusion time steps t. By Equation [8], systems and methods provided herein may compute the gradient with respect to θ,

$$( e . g . , \frac{\partial {Loss}_{ELBO}}{\partial θ} ) ,$$

and continue updating the parameter θ, until specified accuracy or iteration number achieved:

$$θ ← θ - η \frac{\partial {Loss}_{ELBO}}{\partial θ} \qquad [ 9 ]$$

As implied by its name, DDPMs may learn the data distribution through a denoising process. According to Equation [7], a well-trained DDPMs may result in a smaller loss in Equation [8], indicating a larger ELBO and thus better likelihood log p(x), indicating x belongs to the trained distribution, (e.g., the normal seismic images). Otherwise, a larger loss value of Equation [8] may indicate the testing image x is an outlier (e.g., anomalies and/or faults). Thus, systems and methods herein can utilize the denoising objective (e.g., the ELBO) of Equation [8] as an indicator for the anomalies within the input image x₀.

### Anomaly Detection by DDPMs

Computation of faults by systems and methods provided herein may be based on an anomaly detection framework. The anomaly detection framework may comprise two steps:

Step one—Neural network ε_{θ}(xₜ, t) training: As described above, by minimization of Equation [8], systems and methods provided herein may train a neural network ε_{θ}(xₜ, t) which can predict the noise in xₜ.

Step two—Computation of the Fault attribute y for seismic image x: A pixel-wise version of Equation [8] may used as the indictor for the anomalies (e.g., the faults):

y= [symbol] _{t,ε}w(t)[ε_{θ}(xₜ=\sqrt{\tilde{α}ₜ}x+\sqrt{1−\tilde{α}ₜ}ε,t)−ε]², [10]
Where w(t) may be considered the weighting term to balance the signal to noise ratio (SNR) at each different time step t. The weighting term may be a critical component in achieving anomaly detection. In some examples, the weighting term may be defined to be:

$$w ( t ) = min ( {SNR}_{t} , 5 ) = min ( \frac{\sqrt{{\tilde{α}}_{t}}}{\sqrt{1 - {\tilde{α}}_{t}}} , 5 ) \qquad [ 11 ]$$

In Equation [10], systems and methods herein provide a first sample time step t and noise E and then add noise to the input image x following Equation [4]. The trained neural network, ε_{θ}(xₜ, t), may take the noise samples as input and may predict the noise ε. If unpredictable noise is detected, this may indicate that the anomaly exists in the input samples and thus, a fault may be detected. For complete evaluation, systems and method provided herein perform multiple sampling operations to obtain multiple samples. The multiple samples may be averaged to obtain the final predicted faults y.

### Extensions for Detection of Other Types of Anomalies

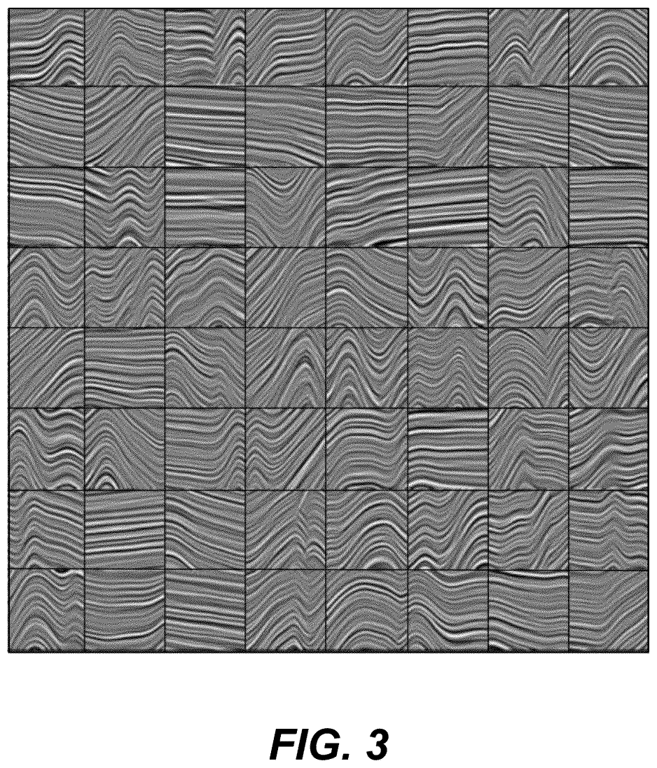

As shown in FIG. 3, the method described above with respect to Equations [1]-[11] may be extended to detect other types of anomalies in seismic images. For example, by proper preparation of a training dataset (e.g., a dataset where anomalies do not exit), systems and methods provided herein can detect geological anomalies such as fluid, amplitude-versus-offset (AVO) anomalies, and/or use the anomalies map (y as in Equation [10]) to locate hydrocarbon indicators (HCI) or direct hydrocarbon indicators (DHI).

The approach provided above with respect to Equations [1]-[11], when implemented on a dedicated computer system for seismic tasks, may be equipped to accurately handle more complex and realistic patterns in a subsurface formation targeted for seismic interpretation. The following discussion is presented to describe systems and methods provided herein, as implemented the approach of Equations [1]-[11].

### Architecture for Implementing Systems and Methods Described

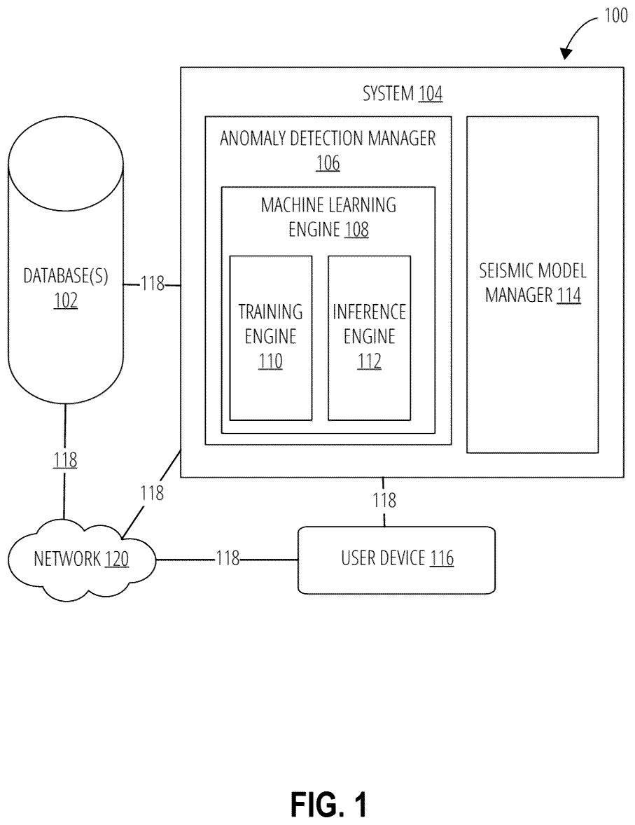

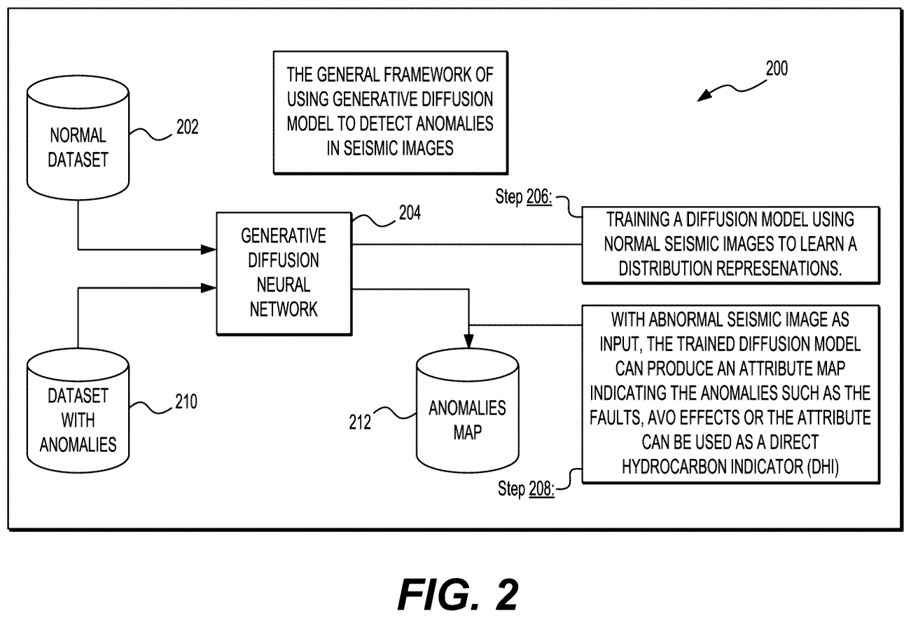

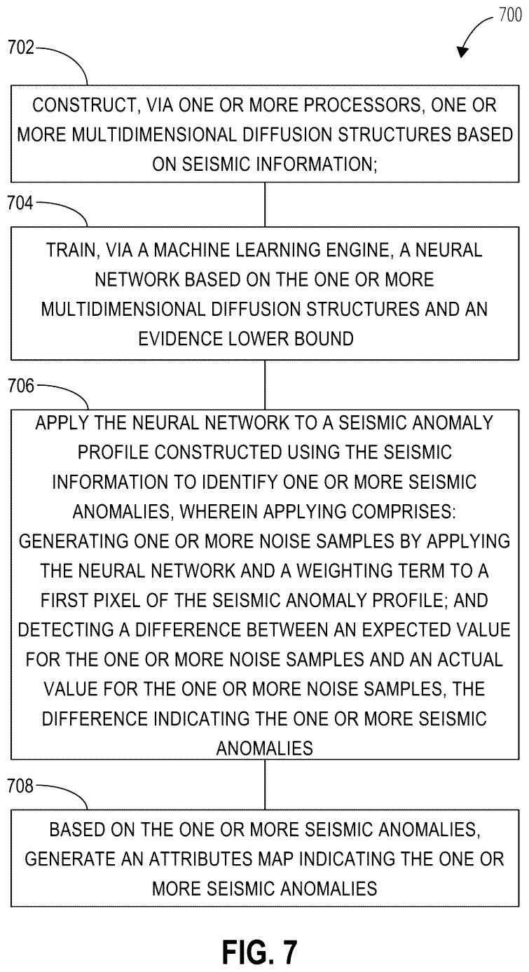

Aspects described herein provide an enhanced anomaly detection architecture (e.g., enhanced anomaly detection architecture 100) in accordance with an embodiment. In at least one aspect, the enhanced anomaly detection architecture is configured or otherwise arranged to perform methods provided herein (e.g., method 700 of FIG. 7). In at least one aspect, the enhanced anomaly detection architecture is configured or otherwise arranged to process data described in further detail with respect to FIGS. 2-6. Additionally, it may be understood that features of FIGS. 2-11 are inherently and broadly described with respect to the enhanced anomaly detection architecture of FIG. 1.

The illustrative diagram of FIG. 1 provides an example of enhanced anomaly detection architecture 100. Unit 104 is coupled through communication pathways 118 to database 102 and user device 116. Communication pathways 118 may also be coupled with database 102, unit 104 and user device 116 over a network 120.

In at least one aspect, an example method of anomaly detection begins at the enhanced anomaly detection architecture 100 when one or more processors of system 104 retrieving, from one or more databases 102 and via network 120, at least one set of seismic information collected over time at a targeted seismic formation. The seismic information may be non-anomalous seismic information. Non-anomalous seismic information may refer to seismic data that does not exhibit any irregularities or deviations from expected geological patterns and is consistent with the known subsurface structures and properties. System 104 proceeds to constructing, for example via one or more processors operating in parallel, one or more DDPMs based on at least one set of seismic information. Each DDPM may be understood to be a multidimensional diffusion structure may be understood to be the multidimensional array described with respect to Equation [1]. In some embodiments, the one or more DDPMs may represent image information, such as geological anomaly information. System 104 may construct the one or more DDPMs by sampling distribution information derived from the seismic information, supplying noise (e.g., Gaussian noise) to distribution information derived from the seismic information. This process may proceed up to a time step value, as described with respect to Equations [2] and [3]. In some cases, each time step value may be considered intermediate samples of noise and data information. System 104 may implement the intermediate samples as latent variables during the training of the neural network (e.g., by way of Bayesian techniques, see discussion of Equation [4], above).

System 104 may proceed to training, via machine learning engine 108 at system 104, a neural network based on the multidimensional diffusion structure and an ELBO value. This process may be understood with respect to the discussion of Equations [4]-[8], above. Machine learning engine 108 may perform training operations using training engine 110 configured to train the neural network and inference engine 112 configured to apply the neural network to a seismic anomaly profile constructed using the set of seismic information. Training engine 110 may input, via one or more processors operating in parallel, the multidimensional diffusion model; and may compare, to a previous output of the neural network, a current outputs of the training engine, wherein comparing is based on at least the first set of noise. Training engine 110 may then proceed to, based on the comparing, adjust one or more weights of the neural network. In some cases, training engine 110 is configured or otherwise arranged to remove noise from the neural network. In some cases, training engine 110 is configured or otherwise arranged to obtain a denoising object by reprioritizing a mean value of one or more DDPMs in relation to at least the removing of the first set of noise (e.g., see Equation [7]). Inference engine 112 may then apply the neural network to seismic anomaly profile (e.g., seismic image, x, of Equation [10]) to identify one or more seismic anomalies (e.g., Fault attribute y, the unpredicted noise according to procedures represented in Equations [10]-[11]). Application of the neural network (e.g., ε_{θ}(xₜ, t) of Equation [10]) may include generating one or more noise samples by applying the neural network and a weighting term (e.g., w(t) of Equations [10]-[11]) to a first pixel (e.g., in a step-wise manner based on value t described with respect to Equations [10]-[11]) of the seismic anomaly profile, and detecting a difference between an expected value for the one or more noise samples and an actual value for the one or more noise samples, the difference indicating the one or more seismic anomalies. The system 104 may then output, via network 120, the one or more seismic anomalies to seismic model manager 114. Seismic model manager 114 may, based on the one or more seismic anomalies, generate an attributes map indicating the one or more seismic anomalies. Seismic model manager 114 may then output the attributes may to user device 116.

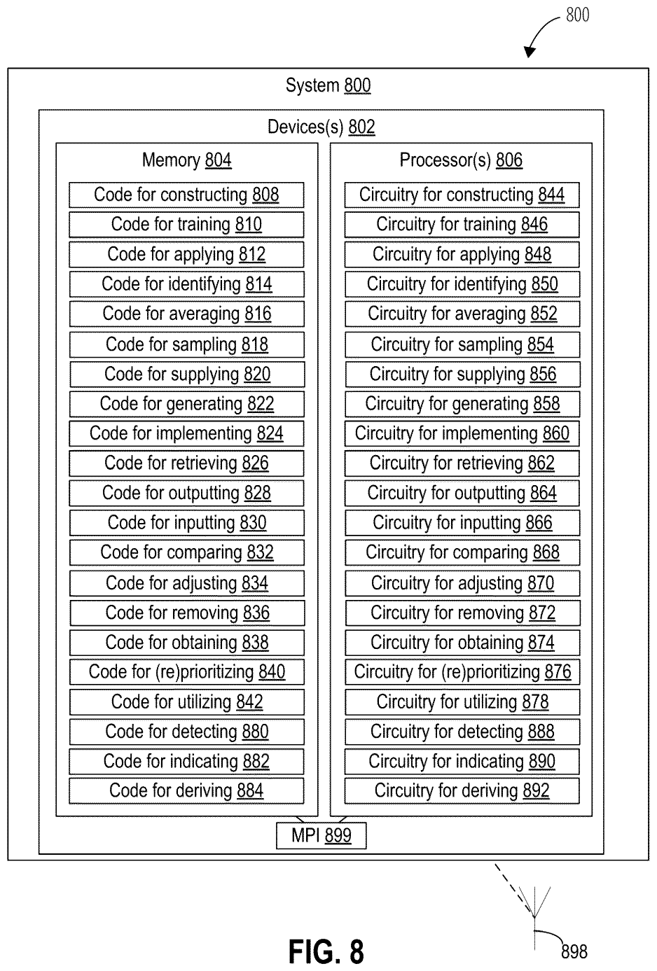

The systems and methods described with respect to FIG. 1 may be further described below with respect to method 700 of FIG. 7 and the system 800 of FIG. 8.

In at least one aspect, each of one or more databases 102, system 104, anomaly detection manager 106, machine learning engine 108, training engine 110, inference engine 112, seismic model manager 114, and/or user device 116 may be practically implemented as one or more units, one or more databases, and/or one or more devices. In at least one aspect, each of one or more databases 102, system 104, anomaly detection manager 106, machine learning engine 108, training engine 110, inference engine 112 seismic model manager 114, and/or user device 116 may have at least one memory and one or more processors having computer readable instructions stored thereon, which are capable of implementing enhanced data processing schemes as part of the enhanced anomaly detection architecture 100. In at least one aspect, one or more databases 102, system 104, anomaly detection manager 106, machine learning engine 108, training engine 110, inference engine 112, seismic model manager 114, and/or user device 116 may have at least one memory and one or more processors having computer readable instructions stored thereon, which are capable of implementing enhanced anomaly detection schemes as part of the function of the enhanced anomaly detection architecture 100. The one or more processor(s) of one or more databases 102, system 104, anomaly detection manager 106, machine learning engine 108, training engine 110, inference engine 112, seismic model manager 114, and/or user device 116 may be central processing units (CPUs). The one or more processor(s) of unit 102, unit 104, unit 106, and/or unit 108 may be graphics processing units (GPUs). Where there is more than one processor, each processor may operate independently from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data (e.g., a Kubernetes-based architecture). Where there is more than one processor, each processor may undergo decomposition to perform some or all of a performance of a method, such as method 700 described herein, in order to increase the efficiency of enhanced anomaly detection architecture 100.

In at least one embodiment, one or more databases 102 may include databases configured for storing seismic data. Data types associated with seismic data include Society of Exploration Geophysicists-Y format (SEG-Y) files, SEG-D format (SEG-D) files, SEG-D, revision 3 (SEGDrev3) files, SEG-Y format (SEG-Y) files, SEG-Y, revision 1 (SEGYrev1) files, Shell Processing Support (SPS) files, United Kingdom Offshore Operators Association-P2/94 format (UKOOA P2/94) files, UKOOA-P6/98 format (UKOOA P6/98) files, Hierarchical Data Format version 5 (HDF5) files, Log ASCII Standard (LAS) files, comma-separated value (CSV) files, extensible Markup Language (XML) files, SEG-C format (SEG-C) files, ZMAP format (ZMAP) files, Geological Object Computer Aided Design (GOCAD) files, Petrel software format files, Kingdom software format files, Georeferenced Tagged Image File Format (GeoTIFF) files, Shapefile format (Shapefile) files, and Network Common Data Form (NetCDF) files. Database types may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. One or more databases 102 may be treated as a data warehouse, data lake, data well, or another storage system. One or more databases 102s may be optimized for seismic interpretation, allowing the enhanced anomaly detection architecture to perform methods described herein (e.g., method 700).

In at least one aspect, network 120 may be practically implemented as one or more networks. Network 120 may be a wired network, a wireless network, or a combination of both. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IoT) applicability), and the like.

In at least one aspect, seismic model manager 114 of the enhanced data processing architecture of FIG. 1 may be accessed by user device 116 via network 120. Seismic model manager 114 may allow a user to control the imaging of various subsurface layers via user device 116. For example, seismic model manager 114 handle the organization, storage, and manipulation of seismic data and models, including one or more seismic anomalies obtained from machine learning engine 108 and generated according to systems and methods described herein. Users can interact with the user device 116 to select specific layers, adjust parameters, and visualize the subsurface structures, which are then processed and rendered by seismic model manager 114. Seismic model manager 114 may support the import and export of various file formats, ensuring compatibility with industry standards. Seismic model manager 114 may facilitate the application of different processing techniques and algorithms described herein to enhance the accuracy and resolution of the seismic images.

In at least one aspect, user device 116 of the enhanced data processing architecture of FIG. 1 includes a browser, which may utilize system 104 and interact with seismic model manager 114. In at least one aspect, system 104 and/or seismic model manager 114 may be accessed by user device 116 via network 120, as described above. In at least one aspect, user device 114 can be any electronic computing device. User device 114 may be a computing device that has a display. A user can enter control inputs through a user interface (such as a keyboard, microphone, or touchscreen). For example, user device 114 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (e.g., wired, or wireless) over network 120. In at least one aspect, user device 116 may be a remote computing device that includes a tool having a user-interface configured to allow a user to view one or more seismic anomaly profiles and/or maps and to make inputs to render or re-render the profiles and/or maps displayed to the user.

### Example Applications of System and Methods Described Herein

FIG. 2 depicts an example of an enhanced framework 200 for anomaly detection, according to at least one aspect of the present disclosure. In at least one aspect, framework 200 may be considered similar to an enhanced anomaly detection architecture, such as enhanced anomaly detection architecture 100 of FIG. 1. In at least one aspect, framework 200 may be encompassed by an enhanced anomaly detection architecture, such as enhanced anomaly detection architecture 100 of FIG. 1.

Framework 200 includes a normal dataset 202 and a generative diffusion neural network 204, which may be configured or otherwise arranged to apply step 206. Framework 200 further includes a dataset 208 with anomalies, which may be processed using neural network 204 to produce anomalies map 212.

Normal dataset 202 may be considered a non-anomalous dataset as described above. Normal dataset 202 may include 2D and/or three dimensional (3D) seismic information. Normal dataset 202 may be configured or otherwise arranged for optimal DDPM processing by neural network 204. Normal dataset 202 may be stored at one or more databases, such as the one or more databases 102 of FIG. 1.

At Step 206, neural network 204 may be trained on normal dataset 202 according to DDPM processes described above with respect to Equations [1]-[8]. Neural network may be implemented on one or more systems, one or more units, one or more devices, and the like, such as system 104 of FIG. 1. At step 208, neural network 204 may be configured or otherwise arranged to be applied to dataset 210. Dataset 210 may be considered an anomalous dataset. Dataset 210 may include one or more abnormal seismic images. Dataset 210 may exhibit nonconventional subsurface characteristics such as faults, fluids, AVO effects, DHIs, and the like. When trained neural network 204 is applied (e.g., at an inference engine) to dataset 210, unpredicted noise may occur at the boundaries (e.g., edges) of anomalies such as faults. Unpredicted noise may be considered a result of the characteristic differences between the normal dataset 202 and dataset 210. Accordingly, the unpredicted noise may create an attribute map of anomalies, which may be overlain on a seismic profile to create an anomaly attribute map.

Production of such an attribute map may be understood with further reference to FIGS. 3-6. FIGS. 3-6 illustrate example image information generated by the systems and methods provided herein. For instance, FIG. 3 depicts “patches” used to train a GDM (e.g., used to generate a neural network). The GDM, which gradually adds noise to a seismic image and reverses the addition of noise to train a model to generate new images, utilizes training based on the patches to parse predictable noise (e.g., added noise) and unpredictable noise (e.g., detected anomalies) at different levels of granularity.

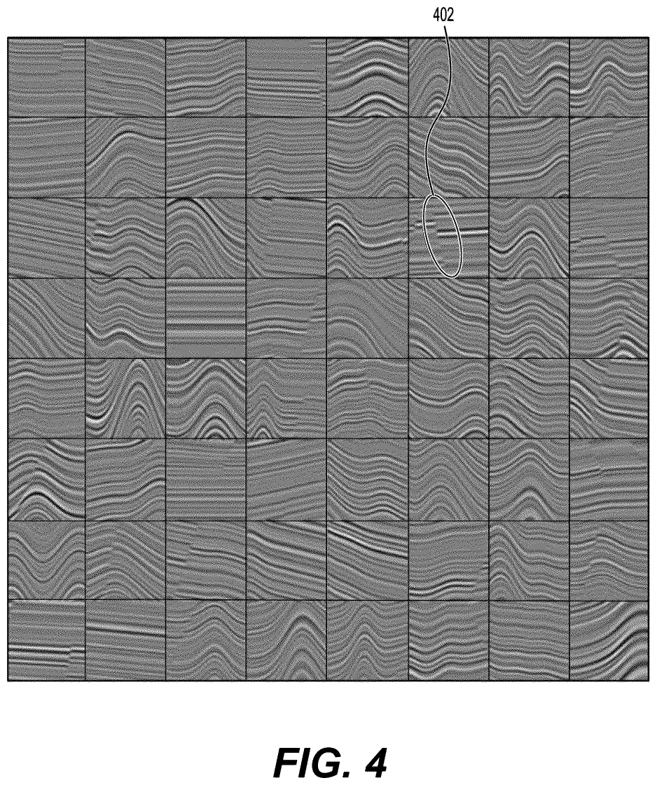

FIG. 3 depicts an example set of DDPM training patches made of non-anomalous 2D seismic profiles, according to at least one aspect of the present disclosure. Notably, each patch of FIG. 3 is absent any anomaly, and may be understood as one example of normal dataset 202 of FIG. 2. During the training phase (e.g., as described about with respect to at least training engine 110), a seismic image can be divided into smaller patches as shown in FIG. 3 (black-line delineation between patches is added for clarity). This may reduce computational complexity and memory usage within a system, especially when dealing with high-resolution seismic images. Each patch may be treated as a separate instance for the purpose of adding noise and denoising. This may allow a model to capture local features more effectively, as the model can focus on smaller regions of the image during training. In some implementations, noise can be added and removed on a patch-by-patch basis. This means that the diffusion process (adding noise) and the reverse process (denoising) are applied to individual patches of FIGS. 4-6 rather than the entire image at once. This may be particularly useful for handling seismic datasets described herein, where systems and methods provided herein are targeting local consistency to capture non-uniform geologic structures and anomalies. The high-resolution layered structures generated as a result of the patching of FIG. 3 may be implemented as a well-trained model for fault detection, reducing inefficiencies associated with anomaly detection in the current state of the art.

FIG. 4 depicts an example set of DDPM input patches corresponding to at least one 2D seismic anomaly profile, according to at least one aspect of the present disclosure. The patches of FIG. 4 may be contrasted with the patches of FIG. 3, because unlike the patches of FIG. 3, the patches of FIG. 4 each display fault anomalies (e.g., like dataset 210). Fault 402 is highlighted for clarity.

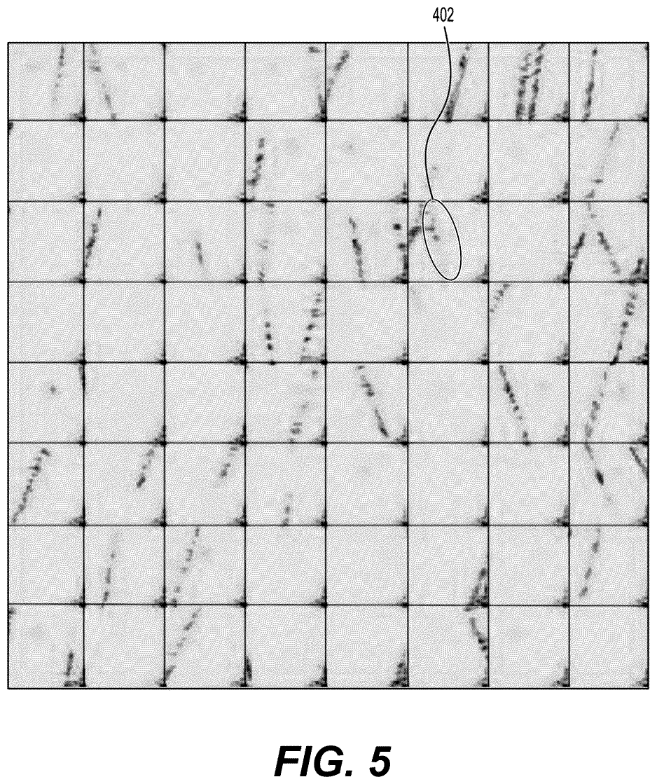

FIG. 5 depicts an example set of detected noise patches corresponding to the patches of FIG. 4, the noise patches indicating predicted and unpredicted noise according to at least one aspect of the present disclosure. Fault 402 is again highlighted for clarity. A DDPM (e.g., neural network 204) trained using the patches of FIG. 3 may encounter the faults of FIG. 4 as noise. When noise is removed from the patches of FIG. 4 to produce the patches of FIG. 5, the noise is removed based on to the predictable noise features of each patch. Noise created by the presence of faults may not be removed because such noise is not predictable. Noise that is not removed appears darker than removed noise in the patches of FIG. 5. Noise generated by the faults present in input seismic data (e.g., like dataset 210) is not predictable because such noise did not originate with the DDPM procedure, but instead with the fault's presence in the seismic profile.

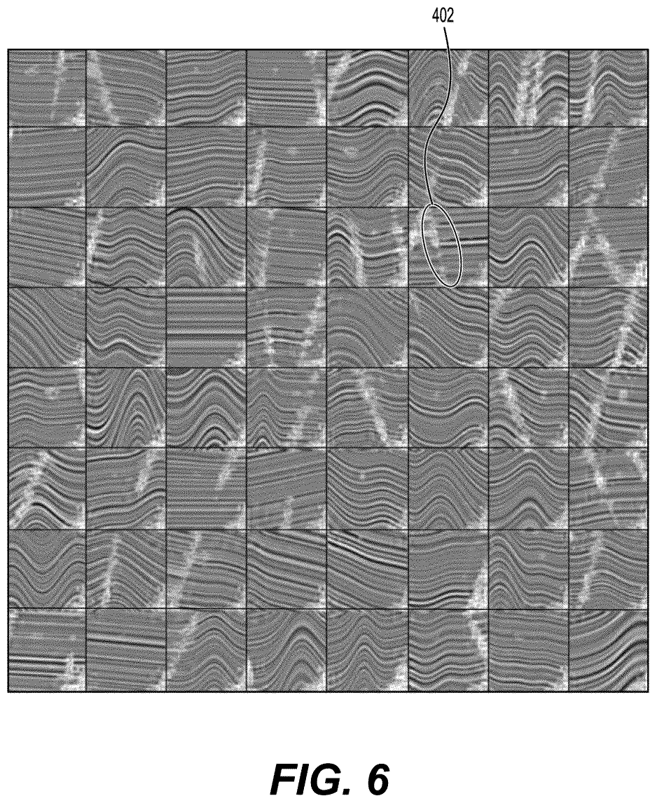

FIG. 6 depicts the patches of FIG. 4 with the unpredicted noise of FIG. 5 overlain to illustrate predicted fault structures, according to at least one aspect of the present disclosure. Fault 402 is again highlighted for clarity. The overlay of FIG. 6 may be representative of one attribute map that may be generated by systems provided herein, though other maps are contemplated within the scope of the disclosure.

Various embodiments described herein can constitute one or more technical improvements over conventional seismic data processing operations by incorporating advanced anomaly detection techniques using DDPMs. Additionally, one or more embodiments described herein can have a practical application by training machine learning models to perform the seismic interpretation operations in accordance with defined geophysical objectives. For example, one or more embodiments described herein can enhance the accuracy and stability of subsurface imaging, specifically with respect to faults and other anomalous structures. Moreover, the machine learning engine can be executed to generate high-resolution layered structures by way of neural networks, which may then serve as well-trained models for precise anomaly detection. Thereby, the seismic data processing engine can apply the neural networks to significantly increase the efficiency and fidelity of seismic interpretation workflows, resulting in more continuous and well-defined imaged anomalies.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various aspects described herein, machine learning models can simulate a number of interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes input into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

### Example Methods

FIG. 7 is a schematic flowchart of an example method 700 for implementing enhanced anomaly detection by one or more processors, such as the processors of system 800 of FIG. 8.

Method 700 begins at operation 702 with one or more processors constructing, via one or more processors, one or more denoising diffusion probabilistic models based on non-anomalous seismic information. In one example, constructing the one or more multidimensional diffusion structures includes sampling at least a first set of distribution information derived from the non-anomalous seismic information. In one example, constructing the one or more multidimensional diffusion structures includes supplying a first set of noise to at least a second set of distribution information derived from the non-anomalous seismic information. In one example, constructing the one or more multidimensional diffusion structures includes sampling at least the second set of distribution information. In one example, the first set of noise is Gaussian noise. In one example, supplying a second set of noise to at least a third set of distribution information derived from the non-anomalous seismic information. In one example, sampling at least the third set of distribution information. In one example, sampling at least the first set of distribution information is based on a first time step value. In one example, supplying the first set of noise to at least a second set of distribution is based on the first time step value or a second time step value. In one example, at least one of the first time step value and the second time step value are intermediate samples, the intermediate samples implemented as latent variables during the training of the neural network.

Method 700 continues to operation 704 with one or more processors training, via a machine learning engine, a neural network based on the one or more denoising diffusion probabilistic models and an evidence lower bound. In one example, the machine learning engine includes a training engine configured to train the neural network and an inference engine configured to apply the neural network to the seismic anomaly profile. In one example, the training engine is configured to train the neural network by inputting the one or more multidimensional diffusion structures. In one example, the training engine is configured to train the neural network by comparing, to a previous output of the neural network, a current outputs of the training engine, wherein comparing is based on at least a first set of noise. In one example, the training engine is configured to train the neural network by, based on the comparing, adjusting one or more weights of the neural network. In one example, the training engine is configured to remove the first set of noise from the neural network. In one example, the training engine is configured to obtain a denoising object by reprioritizing a mean value of the one or more multidimensional diffusion structures in relation to at least the removing of the first set of noise.

Method 700 continues to operation 706 with one or more processors applying the neural network to a seismic anomaly profile constructed using the non-anomalous seismic information to identify one or more seismic anomalies. In one example, applying includes generating one or more noise samples by applying the neural network and a weighting term to a first pixel of the seismic anomaly profile. In one example, applying includes detecting a difference between an expected value for the one or more noise samples and an actual value for the one or more noise samples, the difference indicating the one or more seismic anomalies. In one example, generating the one or more noise samples by iteratively applying the neural network and the weighting term to a second pixel of the seismic anomaly profile. In one example, the weighting term is applied based on a time step value. In one example, the one or more noise samples include a plurality of noise samples derived from the first pixel and the second pixel. In one example, applying the neural network to the seismic anomaly profile further includes averaging the plurality of noise samples to generate a refined set of one or more anomalies.

Method 700 continues to operation 708 with one or more processors, based on the one or more seismic anomalies, generating an attributes map indicating the one or more seismic anomalies.

Method 700 may optionally continue with one or more processors retrieving, from a database, the non-anomalous seismic information collected over time at a targeted rock formation. In one example, the retrieving is performed using a network.

Method 700 may optionally continue with one or more processors outputting the one or more seismic anomalies to an output device. In one example, the outputting is performed using a network.

Method 700 may optionally continue with one or more processors constructing a representative fault based on the one or more seismic anomalies.

Method 700 may optionally continue with one or more processors constructing at least one of a body of fluid, an AVO anomaly, a HCI, and a DHI.

In one aspect, method 700, or any aspect related to it, may be performed by a system, device, apparatus, or architecture, such as the architecture 100 of FIG. 1 or system 800 of FIG. 8, which includes various components operable, configured to, or adapted to perform the method 700. System 800 is described below in further detail.

FIG. 7 is just one example of a method, and other methods including fewer, additional, or alternative operations are contemplated consistent with the disclosure.

### Example Systems

FIG. 8 illustrates a schematic diagram of an example system 800. The system 800 may be implemented as part of the enhanced anomaly detection described with respect to FIGS. 1-7. Components of the system may be implemented at a single location or at multiple locations and may be a supervisory system or may be in communication with a supervisory system by way of a communication line. In at least one embodiment, the communication line may be a wireless communication line, a wired communication line, or both, though other types of communication line are contemplated.

The device(s) 802 may include a CPU processing system, which may be configured to perform anomaly detection procedures, such as those described herein with respect to FIG. 1-7, as performed by the system 800. The CPU processing system of the device(s) 802 may include one or more processors 806 coupled to a computer readable medium/memory 804, for example via a bus (not shown). The one or more processors 806 and the computer readable medium/memory 804 may communicate via a message passing interface (MPI) 899. In certain aspects the computer readable medium/memory 804 is configured to store instructions (e.g., computer executable code) that when executed by the one or more processors 806, cause the one or more processors to perform the method 700 described with respect to FIG. 7, or any aspect related to it. Reference to a single processor performing a function of system 800 may include one or more processors performing that function of system 800.

In the depicted example, computer-readable medium/memory 804 stores code (e.g., executable instructions) 808 for constructing, code 810 for training, code 812 for applying, code 814 for identifying, code 816 for averaging, code 818 for sampling, code 820 for supplying, code 822 for generating, code 824 for implementing, code 826 for retrieving, code 828 for outputting, code 830 for inputting, code 832 for comparing, code 834 for adjusting, code 836 for removing, code 838 for obtaining, code 840 for (re) prioritizing, code 842 for utilizing, code 880 for detecting, code 882 for indicating, and code 884 for deriving. Processing of code 808-842 and code 880-884 may cause the system 800 to perform the method 700 described with respect to FIG. 7, or any aspect related to it.

The one or more processors 806 include circuitry configured to implement (e.g., execute) the code stored in the computer-readable medium/memory 804, including circuitry 844 for constructing, circuitry 846 for training, circuitry 848 for applying, circuitry 850 for identifying, circuitry 852 for averaging, circuitry 854 for sampling, circuitry 856 for supplying, circuitry 858 for generating, circuitry 860 for implementing, circuitry 862 for retrieving, circuitry 864 for outputting, circuitry 866 for inputting, circuitry 868 for comparing, circuitry 870 for adjusting, circuitry 872 for removing, circuitry 874 for obtaining, circuitry 876 for (re) prioritizing, circuitry 878 for utilizing, circuitry 888 for detecting, circuitry 890 for indicating, and circuitry 892 for deriving. Processing with circuitry 844-878 and circuitry 888-892 may cause the system 800 to perform the method 700 described with respect to FIG. 7, or any aspect related to it.

Various components of the system 800 may provide means for performing the method 700 described with respect to FIG. 7, or any aspect related to it.

The system 800 may include or be substantially coupled to a communication component 898. In the depicted example, the communication component 898 is an antenna capable of communicating with controllers similar to system 800 to perform the method 700 described with respect to FIG. 7, or any aspect related to it. In additional examples, the communication component 898 may be a bus or a wired connection.

### Example Computer System

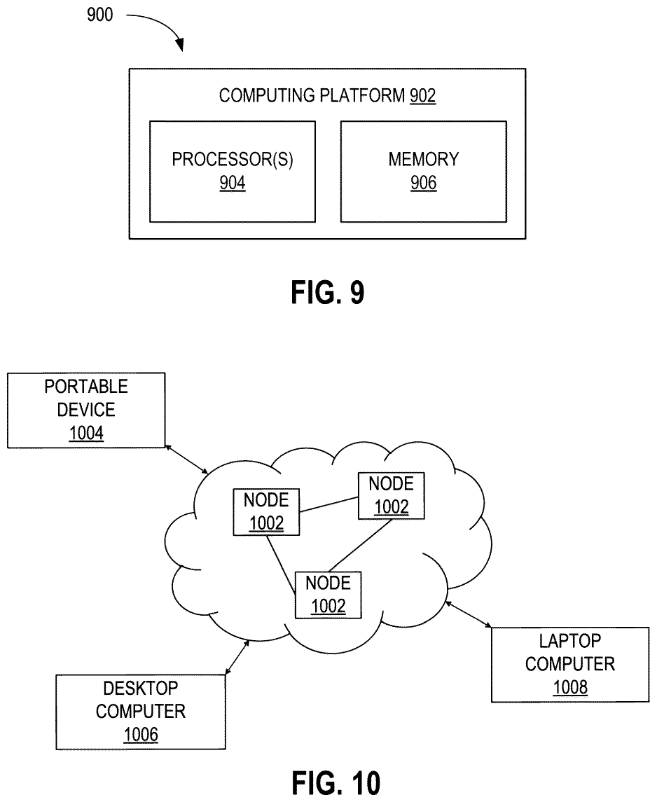

FIG. 9 is an example of a block diagram of a system 900. System 900 can be implemented using one or more modules, shown in block form in the drawings. The one or more modules can be in software or hardware form, or a combination thereof. In some examples, System 900 can be implemented as machine readable instructions for execution on one or more computing platforms 902 (referred to as a computing platform herein), as shown in FIG. 9. The computing platform 902 can include one or more computing devices selected from, for example, a desktop computer, a server, a controller, a blade, a mobile phone, a tablet, a laptop, a personal digital assistant (PDA), and the like.

The computing platform 904 can include a processor 904 and a memory 906. By way of example, the memory 906 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 904 can be implemented, for example, as one or more processor cores. The memory 906 can store machine-readable instructions that can be retrieved and executed by the processor 904 to implement system 900. Each of the processor 904 and the memory 906 can be implemented on a similar or a different computing platform. The computing platform 902 can be implemented in a cloud computing environment (for example, as disclosed herein) and thus on a cloud infrastructure. In such a situation, features of the computing platform 902 can be representative of a single instance of hardware or multiple instances of hardware executing across the multiple of instances (e.g., distributed) of hardware (e.g., computers, routers, memory, processors, or a combination thereof). Alternatively, the computing platform 902 can be implemented on a single dedicated server or workstation.

Cloud computing is a model of service delivery for enabling convenient, on-demand net-work access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service orient-ed with a focus on statelessness, low coupling, modularity, and semantic interoperability.

FIG. 10 is an example of a cloud computing environment 1000 that can be used for implementing one or more modules and/or systems in accordance with one or more examples, as disclosed herein. Thus, reference can be made to one or more examples of FIGS. 1-9 in the example of FIG. 10. As shown, cloud computing environment 1000 can include one or more cloud computing nodes 1002 with which local computing devices used by cloud consumers (or users), such as, for example, personal digital assistant (PDA), cellular, or portable device 1004, a desktop computer 1006, and/or a laptop computer 1008, may communicate. The computing nodes 1002 can communicate with one another. In some examples, the computing nodes 1002 can be grouped (not shown) physically or virtually, in one or more networks, such as Private, Community, Public, or Hybrid clouds, or a combination thereof. This allows the cloud computing environment 1000 to offer infrastructure, platforms and/or software as services for which a cloud consumer does not need to maintain resources on a local computing device. The devices 1004-1008, as shown in FIG. 10, are intended to be illustrative and that computing nodes 1002 and cloud computing environment 1000 can communicate with any type of computerized device over any type of network and/or network addressable connection (e.g., using a web browser). In some examples, the one or more computing nodes 1002 are used for implementing one or more examples disclosed herein relating to root-source identification. Thus, in some examples, the one or more computing nodes can be used to implement modules, platforms, and/or systems, as disclosed herein.

In some examples, the cloud computing environment 1000 can provide one or more functional abstraction layers. It is to be understood that the cloud computing environment 1000 need not provide all of the one or more functional abstraction layers (and corresponding functions and/or components), as disclosed herein. For example, the cloud computing environment 1000 can provide a hardware and software layer that can include hardware and software com-ponents. Examples of hardware components include: mainframes; RISC (Reduced Instruction Set Computer) architecture based servers; servers; blade servers; storage devices; and networks and networking components. In some embodiments, software components include network ap-plication server software and database software.

In some examples, the cloud computing environment 1000 can provide a virtualization layer that provides an abstraction layer from which the following examples of virtual entities may be pro-vided: virtual servers; virtual storage; virtual networks, including virtual private networks; virtual applications and operating systems; and virtual clients. In some examples, the cloud computing environment 1000 can provide a management layer that can provide the functions described be-low. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1000, and billing or invoicing for consumption of these resources. In one example, these re-sources may include application software licenses. Security provides identity verification for cloud consumers and tasks, as well as protection for data and other resources. The management layer can also provide a user portal that provides access to the cloud computing environment 1000 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing re-sources for which a future requirement is anticipated in accordance with an SLA.

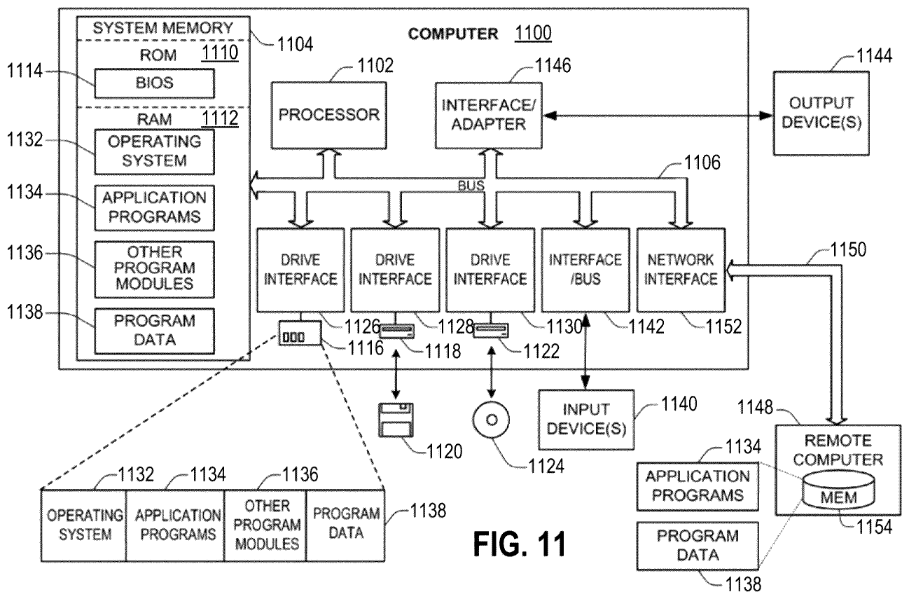

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 11. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as ap-propriate.

Certain embodiments have also been described herein with reference to block illustrations of methods, systems, and computer program products. It will be understood that blocks and/or combinations of blocks in the illustrations, as well as methods or steps or acts or processes de-scribed herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to pro-duce a machine, such that the instructions of the machine, when executed by the processor, implement the functions specified in the block or blocks, or in the acts, steps, methods and process-es described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 11 illustrates one example of a computer system 1100 that can be employed to execute one or more embodiments of the present disclosure. Computer system 1100 can be implemented on one or more general purpose networked computer systems, embedded computer systems, routers, switches, server devices, client devices, various intermediate devices/nodes or standalone computer systems. Additionally, computer system 1100 can be implemented on various mobile clients such as, for example, a personal digital assistant (PDA), laptop computer, pager, and the like, provided it includes sufficient processing capabilities.

Computer system 1100 includes processing unit 1102, system memory 1104, and system bus 1106 that couples various system components, including the system memory 1104, to processing unit 1102. System memory 1104 can include volatile (e.g., RAM, DRAM, SDRAM, Double Data Rate (DDR) RAM, etc.) and non-volatile (e.g., Flash, NAND, etc.) memory. Dual microprocessors and other multi-processor architectures can also be used as processing unit 1102. System bus 1106 may be any of several types of bus structure including a memory bus or memory controller, a peripheral bus, and a local bus using any of a variety of bus architectures. System memory 1104 includes read only memory (ROM) 1110 and random access memory (RAM) 1112. A basic input/output system (BIOS) 1114 can reside in ROM 1110 containing the basic routines that help to transfer information among elements within computer system 1100.

Computer system 1100 can include a hard disk drive 1116, magnetic disk drive 1118, e.g., to read from or write to removable disk 1120, and an optical disk drive 1122, e.g., for reading CD-ROM disk 1124 or to read from or write to other optical media. Hard disk drive 1116, magnetic disk drive 1118, and optical disk drive 1122 are connected to system bus 1106 by a hard disk drive interface 1126, a magnetic disk drive interface 1128, and an optical drive interface 1130, respectively. The drives and associated computer-readable media provide nonvolatile storage of data, data structures, and computer-executable instructions for computer system 1100. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

Computer system 1100 may operate in a networked environment using logical connections to one or more remote computers, such as remote computer 1148. Remote computer 1148 may be a workstation, computer system, router, peer device, or other common network node, and typically includes many or all the elements described relative to computer system 1100. The logical connections, schematically indicated at 1150, can include a local area net-work (LAN) and/or a wide area network (WAN), or a combination of these, and can be in a cloud-type architecture, for example configured as private clouds, public clouds, hybrid clouds, and multi-clouds. When used in a LAN networking environment, computer system 1100 can be connected to the local network through a network interface or adapter 1152. When used in a WAN networking environment, computer system 1100 can include a modem, or can be connected to a communications server on the LAN. The modem, which may be internal or external, can be connected to system bus 1106 via an appropriate port interface. In a networked environment, application programs 1134 or program data 1138 depicted relative to computer system 1100, or portions thereof, may be stored in a remote memory storage device 1154.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rap-idly provisioned and released with minimal management effort or interaction with a provider of the service. This cloud model may include at least five characteristics, at least three service models (e.g., software as a service (Saas, platform as a service (PaaS), and/or infrastructure as a ser-vice (IaaS)) and at least four deployment models (e.g., private cloud, community cloud, public cloud, and/or hybrid cloud). A cloud computing environment can be service oriented with a focus on statelessness, low coupling, modularity, and semantic interoperability.

### Example Aspects

Implementation examples are described in the following numbered clauses:

Aspect 1: A system for seismic processing, including: a memory; and one or more processors coupled to the memory, the memory having computer-readable code stored thereon configured to cause the one or more processors to perform: constructing, via the one or more processors, one or more multidimensional diffusion structures based on non-anomalous seismic information; training, via a machine learning engine at the system, a neural network based on the one or more multidimensional diffusion structures and at least one loss function of an evidence lower bound; and applying the neural network to a seismic anomaly profile constructed using the non-anomalous seismic information to identify one or more seismic anomalies, wherein applying includes: generating one or more noise samples by applying the neural network and a weighting term to a first pixel of the seismic anomaly profile; and detecting a difference between an expected value for the one or more noise samples and an actual value for the one or more noise samples, the difference indicating the one or more seismic anomalies; and based on the one or more seismic anomalies, generating an attributes map indicating the one or more seismic anomalies.

Aspect 2: The system of aspect 1, wherein constructing the one or more multidimensional diffusion structures includes: sampling at least a first set of distribution information derived from the non-anomalous seismic information; supplying a first set of noise to at least a second set of distribution information derived from the non-anomalous seismic information; and sampling at least the second set of distribution information.

Aspect 3: The system of aspect 2, wherein the first set of noise is Gaussian noise.

Aspect 4: The system of any one of aspects 2 through 3, wherein constructing further includes: supplying a second set of noise to at least a third set of distribution information derived from the non-anomalous seismic information; and sampling at least the third set of distribution information.

Aspect 5: The system of any one of aspects 2 through 4, wherein: sampling at least the first set of distribution information is based on a first time step value; and supplying the first set of noise to at least a second set of distribution is based on the first time step value or a second time step value.

Aspect 6: The system of aspect 5, wherein at least one of the first time step value and the second time step value are intermediate samples, the intermediate samples implemented as latent variables during the training of the neural network.

Aspect 7: The system of any one of aspects 1 through 6, wherein the memory having the computer-readable code stored thereon is further configured to cause the one or more processors to perform: retrieving, from a database, the non-anomalous seismic information collected over time at a targeted rock formation; and outputting the one or more seismic anomalies to an output device.

Aspect 8: The system of aspect 7, wherein the retrieving and the outputting are performed using a network.

Aspect 9: The system of any one of aspects 1 through 8, wherein the memory having the computer-readable code stored thereon is further configured to cause the one or more processors to perform: constructing a representative fault based on the one or more seismic anomalies.

Aspect 10: The system of any one of aspects 1 through 9, wherein the memory having the computer-readable code stored thereon is further configured to cause the one or more processors to perform: constructing at least one of a body of fluid, an AVO anomaly, a HCI, and a DHI.

Aspect 11: The system of any one of aspects 1 through 10, wherein the machine learning engine includes a training engine configured to train the neural network and an inference engine configured to apply the neural network to the seismic anomaly profile.

Aspect 12: The system of aspect 11, wherein the training engine is configured to train the neural network by: inputting the one or more multidimensional diffusion structures; comparing, to a previous output of the neural network, a current outputs of the training engine, wherein comparing is based on at least a first set of noise; and based on the comparing, adjusting one or more weights of the neural network.

Aspect 13: The system of aspect 12, wherein the training engine is configured to remove the first set of noise from the neural network.

Aspect 14: The system of aspect 13, wherein the training engine is configured to obtain a denoising object by reprioritizing a mean value of the one or more multidimensional diffusion structures in relation to at least the removing of the first set of noise.

Aspect 15: The system of any one of aspects 1 through 14, wherein applying the neural network to the seismic anomaly profile further includes: generating the one or more noise samples by iteratively applying the neural network and the weighting term to a second pixel of the seismic anomaly profile.

Aspect 16: The system of aspect 15, wherein the weighting term is applied based on a time step value.

Aspect 17: The system of any one of aspects 15 through 16, wherein: the one or more noise samples include a plurality of noise samples derived from the first pixel and the second pixel; and applying the neural network to the seismic anomaly profile further includes averaging the plurality of noise samples to generate a refined set of one or more anomalies.

Aspect 18: A method for seismic processing, including: constructing, via one or more processors, one or more denoising diffusion probabilistic models based on non-anomalous seismic information; training, via a machine learning engine, a neural network based on the one or more denoising diffusion probabilistic models and an evidence lower bound; and applying the neural network to a seismic anomaly profile constructed using the non-anomalous seismic information to identify one or more seismic anomalies, wherein applying includes: generating one or more noise samples by applying the neural network and a weighting term to a first pixel of the seismic anomaly profile; detecting a difference between an expected value for the one or more noise samples and an actual value for the one or more noise samples, the difference indicating the one or more seismic anomalies; and based on the one or more seismic anomalies, generating an attributes map indicating the one or more seismic anomalies.

Aspect 19: The method of aspect 18, wherein applying the neural network to the seismic anomaly profile further includes: generating the one or more noise samples by iteratively applying the neural network and the weighting term to a second pixel of the seismic anomaly profile.

Aspect 20: The method of aspect 19, wherein: the one or more noise samples include a plurality of noise samples derived from the first pixel and the second pixel; and applying the neural network to the seismic anomaly profile further includes averaging the plurality of noise samples to generate a refined set of one or more anomalies.

Aspect 21: A system for seismic processing, including an anomaly detection manager, the anomaly detection manager configured to construct one or more multidimensional diffusion structures based on non-anomalous seismic information and including: a training engine configured to train a neural network based on the one or more multidimensional diffusion structures and at least one loss function of an evidence lower bound; and an inference engine electronically coupled to the training engine and configured to apply the neural network to a seismic anomaly profile constructed using the non-anomalous seismic information to identify one or more seismic anomalies, wherein applying includes: generating one or more noise samples by applying the neural network and a weighting term to a first pixel of the seismic anomaly profile; and detecting a difference between an expected value for the one or more noise samples and an actual value for the one or more noise samples, the difference indicating the one or more seismic anomalies; and a seismic model manager electronically coupled to the anomaly detection manager and configured to, based on the one or more seismic anomalies, generating an attributes map indicating the one or more seismic anomalies

Aspect 22: An apparatus or device including a memory comprising executable instructions, and a processor configured to execute the executable instructions and cause the apparatus to perform a method in accordance with any one of aspects 1-21.

Aspect 23: An apparatus or device, including means for performing a method in accordance with any one of aspects 1-21.

Aspect 24: A non-transitory computer-readable medium including executable instructions that, when executed by a processor of an apparatus, cause the apparatus to perform a method in accordance with any one of aspects 1-21.

Aspect 25: A computer program product embodied on a computer-readable storage medium comprising code for performing a method in accordance with any one of aspects 1-21.

### Additional Considerations

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

The present disclosure may be a system, a method, and/or a computer program product at any possible technical detail level of integration. The computer program product may include a computer readable storage medium (or media) having computer readable program instructions thereon for causing a processor to conduct aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or conduct combinations of special purpose hardware and computer instructions. The terminology used herein is for the purpose of describing particular embodiments only and is not intended to limit the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for conducting this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system for seismic processing, comprising:
a memory; and
one or more processors coupled to the memory, the memory having computer-readable code stored thereon configured to cause the one or more processors to perform:
constructing, via the one or more processors, one or more multidimensional diffusion structures based on non-anomalous seismic information;
training, via a machine learning engine, a neural network based on the one or more multidimensional diffusion structures and at least one loss function of an evidence lower bound;
applying the neural network to a seismic anomaly profile constructed using the non-anomalous seismic information to identify one or more seismic anomalies, wherein applying includes:
generating one or more noise samples by applying the neural network and a weighting term to a first pixel of the seismic anomaly profile; and
detecting a difference between an expected value for the one or more noise samples and an actual value for the one or more noise samples, the difference indicating the one or more seismic anomalies; and
based on the one or more seismic anomalies, generating an attributes map indicating the one or more seismic anomalies.

2. The system of claim 1, wherein constructing the one or more multidimensional diffusion structures comprises:
sampling at least a first set of distribution information derived from the non-anomalous seismic information;
supplying a first set of noise to at least a second set of distribution information derived from the non-anomalous seismic information; and
sampling at least the second set of distribution information.

3. The system of claim 2, wherein the first set of noise is Gaussian noise.

4. The system of claim 2, wherein constructing further comprises:
supplying a second set of noise to at least a third set of distribution information derived from the non-anomalous seismic information; and
sampling at least the third set of distribution information.

5. The system of claim 2, wherein:
sampling at least the first set of distribution information is based on a first time step value; and
supplying the first set of noise to at least a second set of distribution is based on the first time step value or a second time step value.

6. The system of claim 5, wherein at least one of the first time step value and the second time step value are intermediate samples, the intermediate samples implemented as latent variables during the training of the neural network.

7. The system of claim 1, wherein the memory having the computer-readable code stored thereon is further configured to cause the one or more processors to perform:
retrieving, from a database, the non-anomalous seismic information collected over time at a targeted rock formation; and
outputting the one or more seismic anomalies to an output device.

8. The system of claim 7, wherein the retrieving and the outputting are performed using a network.

9. The system of claim 1, wherein the memory having the computer-readable code stored thereon is further configured to cause the one or more processors to perform: constructing a representative fault based on the one or more seismic anomalies.

10. The system of claim 1, wherein the memory having the computer-readable code stored thereon is further configured to cause the one or more processors to perform: constructing at least one of a body of fluid, an amplitude-versus-offset (AVO) anomaly, a hydrocarbon indicators (HCI), and a direct hydrocarbon indicators (DHI).

11. The system of claim 1, wherein the machine learning engine comprises a training engine configured to train the neural network and an inference engine configured to apply the neural network to the seismic anomaly profile.

12. The system of claim 11, wherein the training engine is configured to train the neural network by:
receiving the one or more multidimensional diffusion structures;
comparing, to a previous output of the neural network, a current outputs of the training engine, wherein comparing is based on at least a first set of noise; and
based on the comparing, adjusting one or more weights of the neural network.

13. The system of claim 12, wherein the training engine is configured to remove the first set of noise from the neural network.

14. The system of claim 13, wherein the training engine is configured to obtain a denoising object by reprioritizing a mean value of the one or more multidimensional diffusion structures in relation to at least the removing of the first set of noise.

15. The system of claim 1, wherein applying the neural network to the seismic anomaly profile further comprises: generating the one or more noise samples by iteratively applying the neural network and the weighting term to a second pixel of the seismic anomaly profile.

16. The system of claim 15, wherein the weighting term is applied based on a time step value.

17. The system of claim 15, wherein:
the one or more noise samples comprise a plurality of noise samples derived from the first pixel and the second pixel; and
applying the neural network to the seismic anomaly profile further includes averaging the plurality of noise samples to generate a refined set of one or more anomalies.

18. A method for seismic processing, comprising:
constructing, via one or more processors, one or more multidimensional diffusion structures based on non-anomalous seismic information;
training, via a machine learning engine, a neural network based on the one or more one or more multidimensional diffusion structures and an evidence lower bound;
applying the neural network to a seismic anomaly profile constructed using the non-anomalous seismic information to identify one or more seismic anomalies, wherein the applying includes:
generating one or more noise samples by applying the neural network and a weighting term to a first pixel of the seismic anomaly profile; and
detecting a difference between an expected value for the one or more noise samples and an actual value for the one or more noise samples, the difference indicating the one or more seismic anomalies; and
based on the one or more seismic anomalies, generating an attributes map indicating the one or more seismic anomalies.

19. The method of claim 18, wherein applying the neural network to the seismic anomaly profile further comprises: generating the one or more noise samples by iteratively applying the neural network and the weighting term to a second pixel of the seismic anomaly profile.

20. A system for seismic processing, comprising:
an anomaly detection manager, the anomaly detection manager configured to construct one or more multidimensional diffusion structures based on non-anomalous seismic information and including:
a training engine configured to train a neural network based on the one or more multidimensional diffusion structures and at least one loss function of an evidence lower bound; and
an inference engine electronically coupled to the training engine and configured to apply the neural network to a seismic anomaly profile constructed using the non-anomalous seismic information to identify one or more seismic anomalies, wherein applying includes:
generating one or more noise samples by applying the neural network and a weighting term to a first pixel of the seismic anomaly profile; and
detecting a difference between an expected value for the one or more noise samples and an actual value for the one or more noise samples, the difference indicating the one or more seismic anomalies; and
a seismic model manager electronically coupled to the anomaly detection manager and configured to, based on the one or more seismic anomalies, generating an attributes map indicating the one or more seismic anomalies.
